(19) United States
(12) Patent Application Publication
(10) Pub. No.: US 2010/0021686 A1
(43) Pub. Date: Jan. 28, 2010

(54) SANDWICH PANEL

(76) Inventors: Francois Groussard, Ambrieres Les Vallees (FR); Philippe Bourgain, Chateauroux (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/295,864

(22) PCT Filed: Apr. 4, 2007
(86) PCT No.: PCT/EP07/53338

§ 371 Date: Sep. 24, 2009

(30) Foreign Application Priority Data
Apr. 4, 2006 (FR) 0602918
Apr. 4, 2006 (FR) 0602919

(51) Int. Cl. B32B 3/10; B32B 7/08; B23P 17/00

(52) U.S. Cl. 428/138; 428/223; 428/195.1; 29/527.1

(57) ABSTRACT

The invention relates to a sandwich panel (100) comprising a facing element (110) and a layer of insulating material (130), the facing element (110) comprising a facing sheet (111) and anchoring means (114) able to hold the facing element (110) in engagement with the layer of insulating material (130) so as to attach the facing sheet (111) mechanically to the layer of insulating material (130). The sandwich panel is particularly resistant to climatic conditions, mechanical impacts as well as the risk of delamination.

The invention concerns the field of sandwich panel.

These panels are used for many applications.

They are used in particular in the field of building and construction, to form partitions, cladding, roofing or flooring for example.

These panels must at once be insulating, resistant to ageing, light and economical.

Sandwich panels generally include two facing sheets and a layer of insulating material sandwiched between the two facing sheets.

Depending on the types of application for which they are intended, different sandwich panels' structures have already been proposed.

When the sandwich panels are used in applications that require high resistance to impact, such as ground panels for example, then the panels have a reinforced structure. To this end, they include thick facing sheets or have a honeycomb structure placed between the facing sheets. These panels have the drawback that they are relatively costly.

In particular, the manufacture of panels that have a honeycomb structure necessitates glueing the honeycomb structure onto the facing sheets by means of special glues that are relatively expensive and that require a drying time that increases the production time of the panel.

Some sandwich panels are used in outdoor applications where they are subject to the vicissitudes of the climate. Sandwich panels that have facing sheets in composite materials, such as polyvinyl chloride (PVC), are vulnerable to thermal shock. In fact, these thermal shocks lead to unglueing of the facing sheets from the layer of insulating material. In order to limit the risks of unglueing or blistering of the facing sheets, one solution consists of creating facing sheets from metal.

However, metal facing sheets have the drawback that they are vulnerable to corrosion, and have significant mass that renders them difficult to handle. In addition, in the case where the panel is cut, the edges of the metal facing sheets have to be treated. Another solution consists of installing protective structures close to the panel in order to protect it.

One aim of the invention is to propose a sandwich panel that has improved strength and resistance.

This problem is solved in the context of this present invention by means of a sandwich panel comprising a facing element and a layer of insulating material, with the facing element having a facing sheet and anchoring means designed to hold the facing element in contact with the layer of insulating material so as to achieve mechanical attachment of the facing sheet onto the layer of insulating material, in where in the facing element is formed by extrusion or rotational moulding of a plastic material or of a composite plastic material.

By “composite plastic material” is meant a material that includes a mixture of plastic material and one other material (such as wood fibre for example).

The anchoring means play a part in the cohesion of the panel.

Because the facing element is held in contact with the layer of insulating material by the anchoring means, the risk of detachment of the facing element and of the layer of insulating material is reduced. The panel therefore has better resistance to the action of the climate.

The facing element can thus be held onto the layer of insulating material firstly by adhesion of the insulating material onto the facing element and secondly by virtue of the anchoring means.

In addition, because the facing element is in a plastic material or in a composite plastic material, it is possible to attach auxiliary elements on the anchoring means (such as battens or distance pieces for example).

The panel can advantageously include the following characteristics:
the anchoring means are located inside the layer of insulating material,
the anchoring means include excrescences extending from the facing element,
the anchoring means include ribs,
the anchoring means have a generally T-shaped cross section,
the facing sheet and the anchoring means are integrally formed as a single part, by extrusion or rotational moulding,
the facing sheet and the anchoring means are formed by extrusion along a direction parallel to a plane in which the facing sheet extends,
the layer of insulating material is continuous,
the layer of insulating material has a microcellular structure,
the layer of insulating material is formed from an expanded polymer,
the facing element includes an intermediate sheet sandwiched between the facing sheet and the layer of insulating material, in contact with the layer of insulating material,
the panel includes connection means allowing assembly of the panel with another similar panel,
the connection means include a female component and a male component with a shape that is complementary to the female component so that the female component is designed to mate with a male component of an adjacent panel,
the facing sheet includes perforations designed to absorb sound waves,
the anchoring means have one clear face, free of any insulating material, with the clear face being designed to receive inserts for fixing auxiliary elements onto the panel,
the facing element lies on a first side of the layer of insulating material, and the clear face of the anchoring elements is directed toward a second side of the layer of insulating material, opposite to the first side,
the panel includes inserts for fixing auxiliary elements onto the panel, with these inserts being fixed to the anchoring means,
the anchoring means have a generally double-T shaped section,
the anchoring means are formed by assembling modular parts,
the anchoring means include a first part and a second part, with the first part being designed to be inserted into the second part, and means for adjusting the position of the first part in relation to the second part in order to establish an anchoring depth of the anchoring means in the layer of insulating material,
the panel includes a cavity formed between the anchoring means, to accommodate strengthening elements,
the facing element constitutes a first facing element and has a first extrusion direction, with the panel having a second facing element with a second extrusion direction, the first and the second facing elements being placed in relation to each other so that the first and the second extrusion directions form a non-zero angle,
the facing element includes spacing means designed to hold the facing sheet away from the layer of insulating material so as to form a space that is free of insulating material between the facing sheet and the layer of insulating material,
the space formed between the facing sheet and the layer of insulating material is filled with air,
the space formed between the facing sheet and the layer of insulating material is filled with elements that possess acoustic absorption properties,
the facing sheet and the spacing means are created as a single part, by extrusion,
the facing sheet and the spacing means are formed by extrusion along a direction parallel to a plane in which the facing sheet extends,
the panel includes marking means indicating possible areas for the attachment of auxiliary elements for the purpose of fixing the auxiliary elements to the anchoring means.

The invention also relates to a method for manufacturing a facing panel, comprising steps of:
forming a facing element with
a facing sheet and anchoring means,
forming a layer of insulating material, with the anchoring means holding the facing element in contact with the layer of insulating material so as to achieve mechanical attachment of the facing sheet onto the layer of insulating material.

The facing element formed can include spacing means, with the spacing means holding the layer of insulating material away from the facing sheet so as to form a space that is free of insulating material between the facing sheet and the layer of insulating material.

The facing element can be formed by extrusion or rotational moulding.

Other characteristics and advantages will emerge from the description that follows, which is purely illustrative and not limiting and which should be read with reference to the following attached figures:

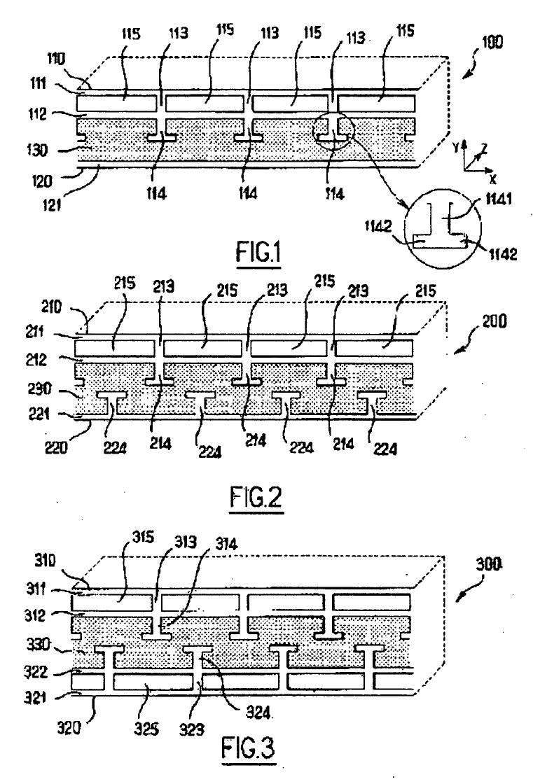

FIG. 1 schematically represents a sandwich panel structure in a first embodiment of the invention,

FIG. 2 schematically represents a sandwich panel structure in a second embodiment of the invention,

FIG. 3 schematically represents a sandwich panel structure in a third embodiment of the invention,

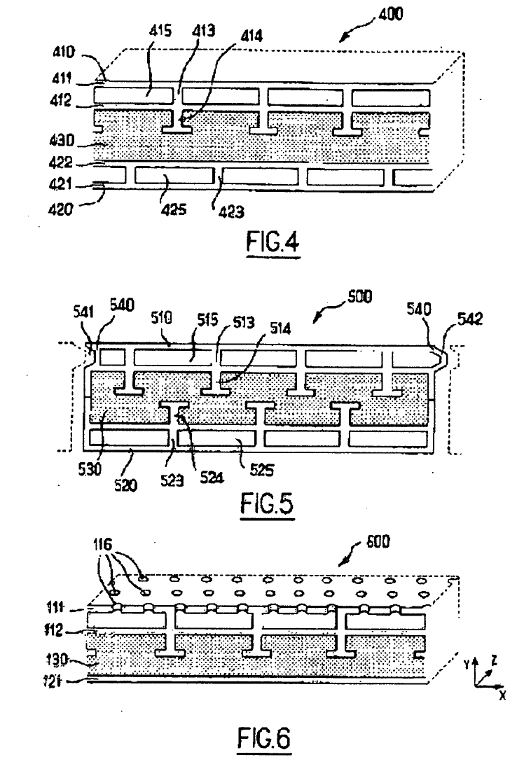

FIG. 4 schematically represents a sandwich panel structure in a fourth embodiment of the invention,

FIG. 5 schematically represents a sandwich panel structure with assembly means,

FIG. 6 schematically represents a sandwich panel structure with acoustic absorption orifices,

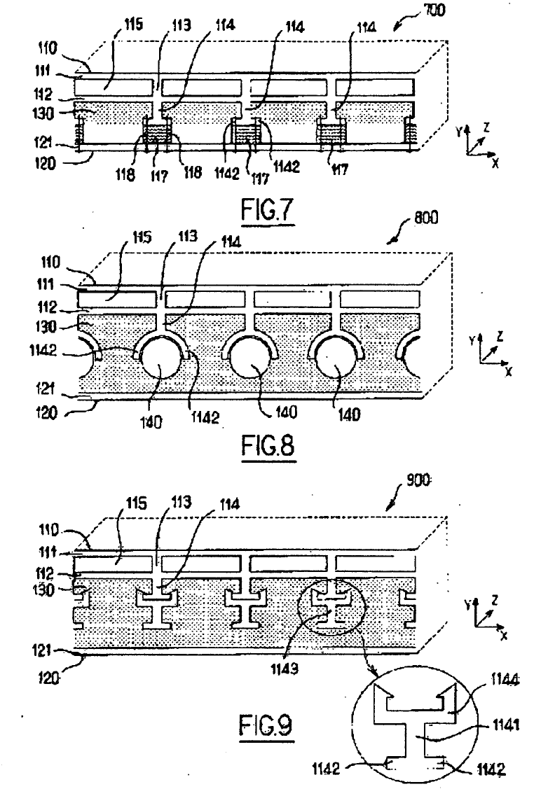

FIG. 7 schematically represents a sandwich panel structure with inserts intended for the attachment of fittings,

FIG. 8 schematically represents a sandwich panel structure with anchoring means designed to receive circulation tubes or ducts,

FIG. 9 schematically represents a sandwich panel structure with anchoring means formed by the assembly of modules,

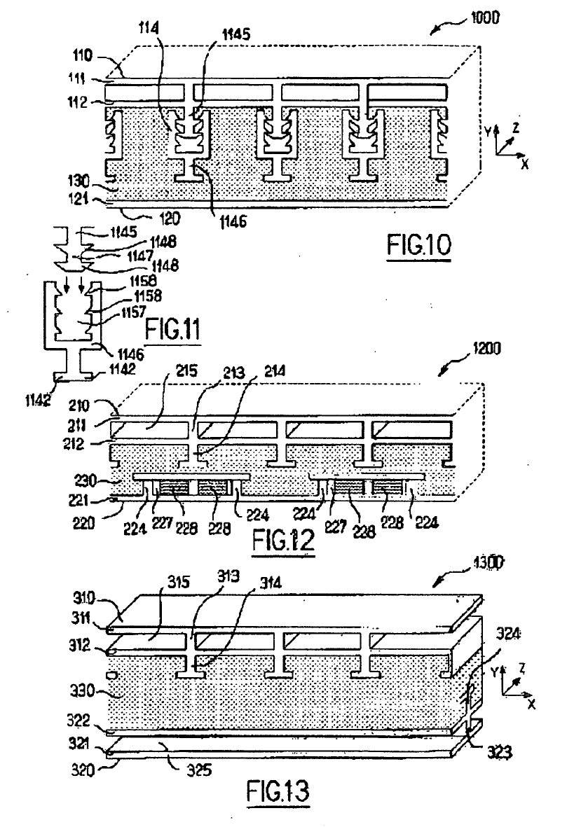

FIGS. 10 and 11 schematically represent a sandwich panel structure with anchoring means formed from two parts,

FIG. 12 schematically represents a sandwich panel structure with cavities intended to receive strengthening elements,

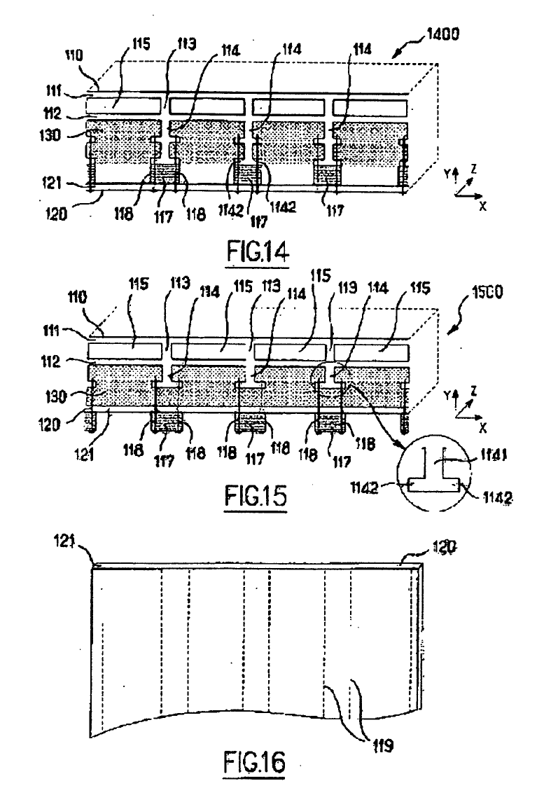

FIG. 13 schematically represents a sandwich panel structure with facing panels oriented at right angles to each other,

FIG. 14 schematically represents a sandwich panel structure with anchoring elements that have a double-T shaped section,

FIG. 15 schematically represents a sandwich panel structure in which auxiliary elements placed outside the panel have been fixed to anchoring means,

FIG. 16 schematically represents a facing sheet bearing means to mark the position of the anchoring means.

In FIGS. 1 to 5, the sandwich panels are shown in section along a plane X-Y, so that the internal structure of the panels is visible.

In FIG. 1, the sandwich panel (100) represented includes a first facing element (110), a second facing element (120) and a core formed of a layer of insulating material (130) sandwiched between the facing elements (110, 120).

The first facing element (110) includes a facing sheet (111), an intermediate sheet (112), spacing means (113) and anchoring means (114).

The first facing element (110), which lies on one side of the layer of insulating material (130), is integrally formed as a single part, by extrusion or rotational moulding of a plastic or plastic composite material, preferably in polyvinyl chloride (PVC).

The facing sheet (111) is intended to be visible. It lies parallel to the intermediate sheet (112), and away from the latter.

The intermediate sheet (112) lies between the facing sheet (111) and the layer of insulating material (130), in contact with the layer of insulating material (130).

The facing sheet (111) is held away from the intermediate sheet (112) and from the layer of insulating material (130) by the spacing means (113). The spacing means (113) include ribs of rectilinear form, parallel to each other and lying in a general direction perpendicular to sheets 111 and 112.

The spacing means (113) are used to create a space that is free of insulating material, between the facing sheet (111) and the intermediate sheet (112). More precisely, the facing sheet (111), the intermediate sheet (112), and the spacing means (113) form a large number of cavities (115) sandwiched between the spacing means (113).

The first facing element (110) is held onto the layer of insulating material (130) firstly by adhesion of the insulating material onto the intermediate sheet (112) and secondly by virtue of the anchoring means (114).

The anchoring means (114) include protuberances lying inside the layer of insulating material (130). The protuberances form an attachment relief so that the first facing element (110) is held in contact with the layer of insulating material (130).

Each protuberance includes a rib (114) projecting from the intermediate sheet (112). The ribs (114) are parallel to each other and have a generally T-shaped cross section.

More precisely, each rib (114) includes a rectilinear central portion (1141) and an anchoring head formed of two wings (1142) extending from the central portion (1141), on either side of the central portion (1141) and perpendicularly to the latter. More precisely, the central portion (1141) includes a first end fixed onto the intermediate sheet (112) and a second end, supporting the wings (1142). The wings (1142) form an anchoring element that resists unglueing of the first facing element (110) from the layer of insulating material (130).

In the embodiment illustrated in FIG. 1, the anchoring means (114) are located in extension of the spacing means (113).

In addition, the first facing element (110) is formed of a channel element that is created by extrusion. The first facing element (110) therefore has a constant section along an extrusion direction (Z) of the first element.

In the embodiment illustrated in FIG. 1, the second facing element (120) includes only a facing sheet (121). The second facing element (120) is formed as a single part, by extrusion of a composite material, preferably polyvinyl chloride (PVC).

In the embodiment of the panel (100) represented in FIG. 1, the first facing element (110) is intended to be exposed to the climatic elements, while the second facing element (120) is rather intended to be protected. This type of panel is designed, for example, to be used as a partition, with an outer surface exposed to radiation from the sun (or to bad weather) and an inner surface intended to be kept away from such radiation.

The layer (130) of insulating material has a microcellular structure. The layer (130) is preferably formed from an expanded polymer, such as a polymer that includes starch, polyethylene (PE), vinylidene polyfluoride, polyurethane, or indeed polyvinyl chloride (PVC). Polyurethane foam in particular has qualities of adherence to many supports. It also has the advantage of being easy to make and of being of moderate cost.

Due to the presence of the space with cavities (115) between the facing sheet (111) and the intermediate sheet (112), the panel (100) possesses enhanced properties of thermal and acoustic insulation.

In addition, due to the presence of the space formed by the cavities (115), which is free of insulating material, the layer (130) of insulating material is located some way back from the facing sheet (111). The layer (130) of insulating material is thus protected by the space that separates it from the facing sheet (111).

In addition, because it includes several sheets (facing sheet (111) and intermediate sheet (112)) as well as anchoring means (114) in the form of a T, the first facing element (111) can easily be equipped with attachment parts, such as screws or nails.

The cavities (115) can be filled with insulating elements used to improve the acoustic absorption properties of the facing panel (100), such as balls of calcium carbonate or a sound insulation material in the form of foam or a gas.

The manufacturing method of the sandwich panel (100) typically includes the following stages:
In a first stage, we manufacture the first facing element (110) and where appropriate the second facing element (120) by extrusion.
In a second stage, we place the two facing elements (110, 120) in a mould. The two facing elements (110, 120) are held at a predetermined distance from each other by means of distance pieces placed in the mould, so as to create a space between the two facing elements (110, 120).
In a third stage, we inject a polymer-type material into the space created between the two facing elements (110, 120). The polymer-type material expands, in such a manner that it fills the space created between the two facing elements (110, 120). In particular, during its expansion, the polymer-type material inserts itself between the anchoring means (114), so that the anchoring means are then in contact with the polymer-type material.
In a fourth stage, when the polymer-type material has solidified, thus forming the layer of insulating material (130), the sandwich panel is removed from the mould.

The distance pieces are used to hold the facing elements (110, 120) in place during the injection and the drying of the polymer-type material, up to the extraction of the panel.

The third stage of injection of a polymer-type material brings about mutual adhesion of the different elements constituting the panel (the facing elements (110, 120), and the layer of insulating material (130)).

This method of manufacturing the sandwich panel is simple and rapid.

In a variant of the manufacturing method, during the third stage, the facing elements (110, 120) are held under pressure so as to improve the adherence between the different elements constituting the panel, and to limit the deformation of the facing elements (110, 120) due to the expansion of the polymer-type material.

In FIG. 2, the sandwich panel (200) represented includes a first facing element (210), a second facing element (220) and a core formed from a layer of insulating material (230) sandwiched between the facing elements (210, 220).

The first facing element (210) is identical to the first facing element (110) of the panel (100) of FIG. 1.

The second facing element (220) includes a facing sheet (221) and anchoring means (224).

The anchoring means (224) of the second facing element (220) are identical to the anchoring means (214) of the first facing element.

The anchoring means (224) include protuberances lying inside the layer of insulating material (230). The protuberances form an attachment relief so that the second facing element (220) is held in contact with the layer of insulating material (230).

Each protuberance includes a rib (224) projecting from the facing sheet (221). The ribs (224) are parallel to each other and have a generally T-shaped cross section.

In a manner similar to the first facing element (210), the second facing element (220) is formed of a channel element that is created by extrusion. The second facing element (220) therefore has a constant section along an extrusion direction (Z).

It can be seen that the anchoring means (214) of the first facing element (210) and the anchoring means (224) of the second facing element. (220) are placed alternately (or in a staggered manner) on either side of the layer of insulating material (230), so as not to weaken the layer of insulating material (230) and to achieve a minimum thickness of this layer (230) over the whole extent of the panel.

In FIG. 3, the sandwich panel (300) represented includes a first facing element (310), a second facing element (320) and a core formed of a layer of insulating material (330) sandwiched between the facing elements (310, 320).

The first facing element (310) and the second facing element (320) are identical to the first facing element (110) of FIG. 1.

The first facing element (310) and the second facing element (320) respectively include a facing sheet (311, 321), an intermediate sheet (312, 322), and spacing means (313, 323) sandwiched between the facing sheet (311, 321), the intermediate sheet (312, 322) and the anchoring means (314, 324) extending from the intermediate sheet (312, 322).

As in the embodiment of FIG. 2, the anchoring means (314) of the first facing element (310) and the anchoring means (324) of the second facing element (320) are placed alternately (or in a staggered manner) on either side of the layer of insulating material (330), so as not to weaken the layer of insulating material (330) and to achieve a minimum thickness of this layer (330) over the whole extent of the panel.

The panel shown in FIG. 3 is particularly designed to be used in applications where each facing element (310, 320) is subject to the climatic elements.

The panel of FIG. 3 is also designed to be used as ground/floor covering, for example as the floor of a sports hall. In fact, the panel (300) has good bounce and shock-absorbing properties.

Because it has two spaces (315, 325) that are free of insulating material, the panel of FIG. 3 is also designed to be used in sound insulation applications.

In FIG. 4, the sandwich panel (400) represented includes a first facing element (410), a second facing element (420) and a core formed of a layer of insulating material (430) sandwiched between the facing elements (410, 420).

The first facing element (410) is identical to the first facing element (110) of the panel (100) of FIG. 1.

The second facing element (420) includes a facing sheet (421), an intermediate sheet (422) and spacing means (423).

The facing sheet (421) lies parallel to the intermediate sheet (422), and away from the latter.

The intermediate sheet (422) lies between the facing sheet (421) and the layer of insulating material (430), in contact with the layer of insulating material (430).

The facing sheet (421) is held away from the intermediate sheet (422) and from the layer of insulating material (430) by the spacing means (423). The spacing means (423) include ribs of rectilinear form, parallel to each other and lying in a general direction perpendicular to the sheets (421, 422).

The spacing means (423) are used to create a space that is free of insulating material between the facing sheet (421) and the intermediate sheet (422). The facing sheet (421), the intermediate sheet (422) and the spacing means (423) form a large number of cavities (425) sandwiched between the spacing means (423).

In the embodiment of the panel (400) represented in FIG. 4, the first facing element (210) is intended to be exposed to the climatic elements, while the second facing element (420) is mostly intended to be protected. This type of panel is designed, for example, to be used as a partition, with an outer surface exposed to radiation from the sun and an inner surface intended to be kept away from this radiation. The panel (400) is an excellent insulation resource.

FIG. 5 schematically represents a sandwich panel (500) with a first facing element (510), a second facing element (520), a core formed of a layer of insulating material (530) and connection means (540).

The connection means (540) allow the assembly of several sandwich panels to each other.

In the embodiment illustrated in FIG. 5, the connection means (540) include a female component (541) and a male component (542) with a shape that is complementary to the female component (541). Thus, each female component (541) is designed to mate with a male component (542) of an adjacent panel.

More precisely, these components (541, 542) are each formed on a section of the sandwich panel (500), on either side of the sandwich panel (500). The female component (541) is designed to be interlocked with a male element (542) formed on a section of an adjacent panel.

To this end, the female component (541) has a cavity of general trapezoidal shape. The male element (542) has a corresponding excrescence, also of general trapezoidal shape, designed to be inserted into the cavity of the female component so as to affect the assembly of two adjacent panels by mechanical attachment.

The components (541, 542) can include parts fitted onto the sandwich panel (500) or be formed as a single part with one of the facing elements (510 or 520) during the extrusion of the latter. Because the components (541, 542) form part of the panel (500), the assembly of panels to each other does not require one to have additional connecting parts. Thus the assembly of several panels can be simple and quick.

The connection means (540) are preferably made from a plastic material so as to limit thermal conduction in the connection means (540) and to preserve the insulation properties of the assembly.

For some applications, it may be useful to arrange for special panels that have only a single connection component (541, 542) or with additional connection components that can be used as corner, edge or finishing panels.

It can also be arranged to add flexible lips or sealing gaskets in order to seal the panel assembly at the connection components.

In particular, the panel can include a co-extruded gasket so as to provide a good seal at the connection between two panels, and to prevent the ingress of water drops.

In a variant of the embodiment of FIG. 5, the connection components include grooves and ribs designed to mate in order to affect the assembly of several panels to each other, as well as a self-tightening cam system designed to prevent any separation of the panels when they are assembled, while also allowing dismantling of the panels if necessary. According to this variant, the female component has the grooves, while the male component has the ribs, designed to be inserted into the grooves of the female component.

According to yet another variant of the embodiment of FIG. 5, the connection components (541, 542) can have shapes so that when the female component (541) is inserted into the male connection component (542), the connection components (541, 542) form a cavity that is suitable to accommodate a sealing gasket. Such a cavity has the advantage that the gasket is protected and cannot be removed from the cavity, in particular under the action of a high-pressure jet directed at the panels for cleaning purposes, for example.

In another embodiment, it is possible to have a connection system of the flexible membrane type, allowing articulation of the panels on each other, as described for example in document WO 2005/045147

In FIG. 6, the facing panel (600) represented is similar to the panel (100) of FIG. 1. One of the facing sheets (111) is equipped with perforations (116). These perforations are used to improve the acoustic absorption properties of the facing panel (100).

In FIG. 7, the facing panel (700) represented is similar to the panel (100) of FIG. 1, except that it includes inserts (117). Each insert (117) is fixed onto an anchoring element (114). These inserts form supports that are intended to receive fixing means (118), such as screws for example, for fixing auxiliary elements onto the panel (700) such as clapboarding, tiles, or facing sheets for example.

As illustrated in FIG. 7, each insert can be fixed onto the anchoring head of the anchoring elements (114).

It will be observed in this figure that the anchoring head of each anchoring element has one free plane face (meaning that it is not covered by a layer of insulating material), with the clear face being designed to receive an insert. Each insert is fixed in contact with the clear face by means of fixing components, such as screws for example. Such fixing is possible because the anchoring elements are formed from a plastic material.

In FIG. 7, the auxiliary elements on the panel are battens or distance pieces that support the facing element (120). The facing element (120) is held away from the layer of insulating material (130), so as to create a space between this layer and the facing sheet (121). In this configuration, it is possible to have cables, pipes, electrical connection points or other elements between the layer of insulating material (130) and the facing element (120). For example, the cables can take the form of cables placed on X and connected to a metal structure in order to create a wind brace or to improve the stability of the panel (in particular when the latter is subject to the action of the wind).

In FIG. 8, the panel (800) represented is similar to the panel (100) of FIG. 1, except that it includes anchoring elements (114) that have a shape that is designed to receive fittings, such as tubes or ducts, for example, for the circulation of fluids or for the passage of cables.

As illustrated in FIG. 8, the anchoring elements (114) have an anchoring head whose wings (1142) are curved, thus forming a half cylinder. The semi-cylindrical anchoring head is designed to receive a tube (140). Each tube (140) is held on an anchoring element (114), between the wings (1142) of the anchoring element (114).

In FIG. 9, the panel (900) represented is similar to the panel (100) of FIG. 1, except that each anchoring element (114) includes the assembly of modules (1143).

Each module (1143) includes a central portion (1141), an anchoring head with wings (1142) and a coupling portion (1144). The coupling portion (1144) is designed to be coupled to an anchoring head (1142) on another identical module (1143). More precisely, the coupling portion (1144) has a shape that is complementary to the shape of the anchoring head, so that the coupling portion (1144) is designed to receive the anchoring head of another identical module (1143).

It is thus possible, by coupling, to assemble a large number of modules (1143) in order to create an anchoring element (114) with the desired dimensions. In particular, the assembly of modules is used to extend the anchoring element (114), according in particular to the thickness of the sandwich panel (900).

In a manner that is advantageous, it is possible to fix each module onto another module by threading (along extrusion direction Z) the coupling portion of one of the modules onto the anchoring head of the adjacent module.

Thus, it is possible to create panels of different thickness as required, from identical modules.

In FIG. 10, the panel (1000) represented is similar to the panel (100) of FIG. 1, except that each anchoring element (114) is formed of two parts (1145, 1146).

Each anchoring element (114) includes a first part (1145) extending from the intermediate sheet (112) and a second part (1146) designed to be fixed onto the first part (1145).

As illustrated more precisely in FIG. 11, the first part (1145) includes a first coupling portion. The first coupling portion includes a central portion (1147) and a large number of reliefs (1148) of sawtooth shape lying along the central portion (1147) on either side of the latter.

The second part (1146) includes a second coupling portion and an anchoring head with two wings (1142). The second coupling portion includes an opening (1157) that is equipped with a large number of reliefs (1158) of sawtooth shape. The first coupling portion is designed to receive the second coupling portion so that the reliefs of sawtooth shape (1148, 1158) are attached to each other so as to fix the second part (1146) onto the first part (1145).

The sawtooth reliefs (1148, 1158) are used to adjust the position of the anchoring element in relation to the facing panel (1000). In fact, the first part (1145) can be inserted at various depths into the second part (1146).

It is thus possible to create panels of different thickness as required, from identical parts.

In FIG. 12, the panel (1200) represented is similar to the panel (200) of FIG. 2, except that it includes cavities (227) that are intended to receive strengthening elements (228).

As illustrated in FIG. 12, the cavities (227) can be formed between two anchoring elements (224).

In FIG. 13, the panel (1300) represented is identical to the panel (300) of FIG. 3, except that the facing elements (310, 320) are oriented at right angles in relation to each other.

In fact, the first facing panel (310) has a constant section in a first extrusion direction Z, while the second facing element (320) has a constant section in a second extrusion direction X, at right angles to the first direction Z.

The result is that the spacing means (313), the cavities (315) and the anchoring means (314) of the first panel (310) are oriented in a direction that is at right angles to the direction in which the spacing means (323), the cavities (325) and the anchoring means (324) of the second panel (320) are oriented.

This has the advantage that the panel (1300) is particularly suitable to be used as ground/floor covering, for the flooring of a sports hall for example. In fact, due to the orientation of the elements (310, 320), the panel (1300) has excellent mechanical strength qualities.

In FIG. 14, the panel (1400) represented is similar to the panel of FIG. 7, except that each anchoring element has a section in the general form of a double-T. This is used to attach each fixing component of the anchoring elements (114) to two walls so as to achieve solid fixing of the auxiliary elements onto the panel, which is then resistant to separation by force.

In FIG. 15, the panel (1500) represented is similar to the panel of FIG. 1. Auxiliary elements placed outside the panel have been fixed to the anchoring means (114).

Such fixing is facilitated by the fact that the facing sheet (120) and the anchoring means (114) are made from a plastic material or a composite plastic material.

FIG. 16 schematically represents a facing element (120) equipped with marking means (119), indicating the positions of the anchoring means (114). On this figure, the marking means are lines printed onto an outer surface of the panel (121). The lines form zones in which it is possible arrange for the fixing components (118) to fix the auxiliary elements (117) onto the anchoring means (114). Naturally, these marking means can take other forms.

In particular, the marking means can be composed of patterns printed onto a film or a sheet that is then used to cover the face of the facing element.

The marking means can also be composed of reliefs formed in the thickness of the sheet (121) (such as grooves or orifices for positioning the fixing components).

It will be seen that the anchoring means can allow the attachment of auxiliary elements on either side of the panel. For example, it is possible to fixer a frame on the inside of the panel, while on a clapboard can be attached to the outside.

It will also be seen that the channel elements forming the sandwich panel can, if necessary, include fittings such as metal strength elements, in plastic or in wood, or indeed tubes or ducts for the circulation of fluids or for the passage of cables.

It will also be observed that the proposed sandwich panels can also have a honeycomb structure, used to add rigidity to the panel.

The proposed sandwich panels can be used in multiple applications, such as the construction of industrial warehouses, especially refrigerated warehouses, cold rooms or structures for the storage of food products, the creation of clean rooms, the construction of hospital operating blocks, the creation of vehicle bodies for the transportation of merchandise or passengers, the insulation of swimming pools, the construction of simple dwellings, of mobile homes, of prefabricated dwellings or house-boats, the creation of machine tools, shower cabins, washrooms, fitting rooms, worksite cabin, and so on.

In addition, the proposed sandwich panels can allow the attachment of vegetation, for the manufacture of planted walls.

The thermal and acoustic insulation properties, the sealing qualities, the resistance to corrosion, the heat resistance, the resistance to climatic conditions, the ease of assembly and removal, and the economic character of the panels that have just been described, renders these panels particularly attractive for use in the many areas mentioned.

In particular, the resistance of the panels to ultraviolet light, by virtue of the space created between the outer sheet and the layer of insulating material, results in an increased life expectancy of the panel in relation to the panels of the prior art.

1. A sandwich panel (100, 200, 300) comprising a facing element (110, 210, 310) and a layer of insulating material (130, 230, 330), with the facing element (110, 210, 310) having a facing sheet (111, 211, 311) and anchoring means (114, 214, 314) designed to hold the facing element (110, 210, 310) in contact with the layer of insulating material (130, 230, 330) so as to achieve mechanical attachment of the facing sheet (111, 211, 311) onto the layer of insulating material (130, 230, 330), wherein the facing element (110, 210, 310) is formed by extrusion or rotational moulding of a plastic material or of a composite plastic material.

2. A panel according to claim 1, wherein the anchoring means (114) are located inside the layer of insulating material (130).

3. A panel according to claim 1, wherein the anchoring means (114) include excrescences extending from the facing element (110).

4. A panel according to claim 1, wherein the anchoring means (114) include ribs.

5. A panel according to claim 1, wherein the anchoring means (114) have a generally T-shaped cross section.

6. A panel according to claim 1, in which the facing sheet (111) and the anchoring means (114) are created as a single part.

7. A panel according to claim 1, wherein the facing sheet (111) and the anchoring means (114) are formed by extrusion along a direction (Z) parallel to a plane wherein the facing sheet extends (111).

8. A panel according to claim 1, wherein the layer of insulating material (130) is continuous.

9. A panel according to claim 1, wherein the layer of insulating material (130) has a microcellular structure.

10. A panel according to claim 1, wherein the layer of insulating material (130) is formed from an expanded polymer.

11. A panel according to claim 1, wherein the facing element (110) includes an intermediate sheet (112) sandwiched between the facing sheet (111) and the layer of insulating material (130), in contact with the layer of insulating material (130).

12. A panel according to claims 1, comprising connection means (540) allowing assembly of the panel with another similar panel.

13. A panel according to claim 12, wherein the connection means (540) includes a female component (541) and a male component (542) with a shape that is complementary to the female component (541) so that the female component (541) is able to mate with a male component (542) of an adjacent panel.

14. A panel according to claim 1, wherein the facing sheet (111) includes perforations (116) designed to absorb sound waves.

15. A panel according to claim 1, wherein the anchoring means (114, 214, 314) have one clear face, free of any insulating material, the clear face being designed to receive inserts (117) for fixing auxiliary elements onto the panel.

16. A panel according to claim 15, wherein the facing element (110, 210, 310) lies on a first side of the layer of insulating material (130, 230, 330), and the clear face of the anchoring elements is directed toward a second side of the layer of insulating material, opposite to the first side.

17. A panel according to claim 1, comprising inserts (117) for fixing auxiliary elements on the panel, the inserts (117) being fixed to the anchoring means (114).

18. A panel according to claim 1, wherein the anchoring means (114) have a generally double-T shaped section.

19. A panel according to claim 1, wherein the anchoring means (114) are formed by assembling modular parts (1143).

20. A panel according to claim 1, wherein the anchoring means (114) include a first part (1145), a second part (1146), with the first part (1145) being designed to be inserted into the second part (1146), and means for adjusting (1148, 1158) the position of the first part in relation to the second part (1146) in order to establish an anchoring depth of the anchoring means in the layer of insulating material (130).

21. A panel according to claim 1, wherein a cavity (227) formed between the anchoring means (224) in order to accommodate strengthening elements (228).

22. A panel according to claim 1, wherein the facing element (310) has a first facing element (310) and has a first extrusion direction (Z), in which the panel has a second facing element (320) with a second extrusion direction (X), with the first and the second facing elements (310, 320) being placed in relation to each other so that the first and the second extrusion directions form a non-zero angle.

23. A panel according to claim 1, wherein the facing element (110, 210, 310) includes spacing means (113, 213, 313) designed to hold the facing sheet (111, 211, 311) away from the layer of insulating material (130, 230, 330) so as to form a space (115, 215, 315) that is free of insulating material between the facing sheet (111, 211, 311) and the layer of insulating material (130, 230, 330).

24. A panel according to claim 23, wherein the space (115) formed between the facing sheet (111) and the layer of insulating material (130) is filled with air.

25. A panel according to claim 23, wherein the space (115) formed between the facing sheet (111) and the layer of insulating material (130) is filled with elements that possess acoustic absorption properties.

26. A panel according to claim 23, in which the facing sheet (111) and the spacing means (113) are created as a single part.

27. A panel according to one of claims 23 to 26, wherein the facing sheet (111) and the spacing means (113), are formed by extrusion along a direction (Z) parallel to a plane in which the facing sheet extends (111).

28. A panel according to of claim 1, comprising marking means (119) indicating possible areas for the attachment of auxiliary elements (117) for the purpose of fixing the auxiliary elements (117) to the anchoring means (114).

29. A method for manufacturing a facing panel (100), comprising steps of:
forming a facing element (110) with a facing sheet (111) and anchoring means (114), by extrusion or rotational moulding of a plastic material or of a composite plastic material
forming a layer of insulating material (130), with the anchoring means (114) holding the facing element (110) in contact with the layer of insulating material (130) so as to achieve mechanical attachment of the facing sheet (111) onto the layer of insulating material (130).

30. A method according to claim 29, wherein the facing element (110) formed includes spacing means (113), with the spacing means (113) holding the layer of insulating material (130) away from the facing sheet (111) so as to form a space (115) that is free of insulating material between the facing sheet (111) and the layer of insulating material (130).
